(19) United States
(12) Patent Application Publication
(10) Pub. No.: US 2012/0088080 A1
(43) Pub. Date: Apr. 12, 2012

(54) PAINT FINISH INCORPORATING DECORATIVE EFFECTS

(76) Inventors: David Castrucci, Novato, CA (US); Roger Shank, Walnut Creek, CA (US); Han Hsin Lin, Taichung Heien (TW)

(21) Appl. No.: 12/899,240

(22) Filed: Oct. 6, 2010

(51) Int. Cl. B32B 3/10; B05D 5/06

(52) U.S. Cl. 428/209; 427/383.1; 427/262; 427/261

(57) ABSTRACT

The present invention relates to a paint finish that incorporates decorative effects such as a laser effect, a splash effect, or a cloud effect, and to a paint process to obtain a paint finish that incorporates decorative effects.

### FIELD OF THE INVENTION

The present invention relates to a paint finish that incorporates decorative effects and to a paint process to obtain a paint finish that incorporates decorative effects.

### BACKGROUND OF THE INVENTION

Paint finishes are commonly used to decorate articles such as scooters (also known as mopeds), bicycles, tricycles, and other types of vehicles. Paint finishes, however, lack decorative effects such as laser effects, splash effects, and cloud effects. To obtain such decorative effects, it is common to affix stickers or decals that resemble the desired decorative effects. Over time, however, these decorative stickers or decals tend to peel off. Therefore, a need exists for a paint finish that incorporates decorative effects directly into the paint finish and do not peel off.

### BRIEF SUMMARY

The present invention provides a paint finish that incorporates a decorative effect directly into the paint finish. An embodiment of the paint finish comprises a coat of a base paint, a coat of a decorative paint, a coat of silver sands, a first coat of clear oil, coat of a transparent paint, and a second coat of clear oil. A decorative effect comprising a laser effect, a splash effect, a cloud effect, or a combination thereof is incorporated into the coat of a decorative paint.

The present invention also provides a paint process to create a paint finish that incorporates a decorative effect directly into the paint finish. An embodiment of the paint process comprises applying a coat of a base paint to a substrate, applying a decorative paint over the coat of a base paint to create a coat of a decorative paint have a decorative effect, applying a coat of silver sands, applying a first coat of clear oil, applying a coat of transparent paint, and applying a second coat of clear oil. Each coat is partially cured before the next coat is applied except that the last coat is completely cured.

An object of the invention is to provide a paint finish that is more fashionable than typical paint finishes used on scooters, bicycles, or tricycles.

### BRIEF DESCRIPTION OF THE DRAWINGS

FIG. 1 is a black and white photograph of a paint finish incorporating the splash effect on a metallic surface.

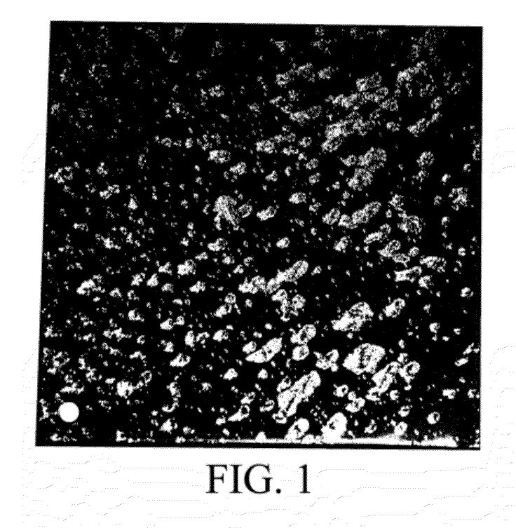

FIG. 2 is a black and white photograph of a paint finish incorporating the laser effect on a metallic surface.

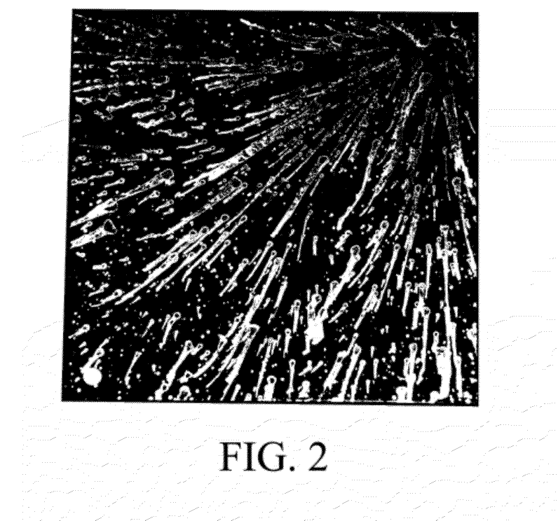

FIG. 3 is a black and white photograph of a paint finish incorporating the cloud effect on a metallic surface.

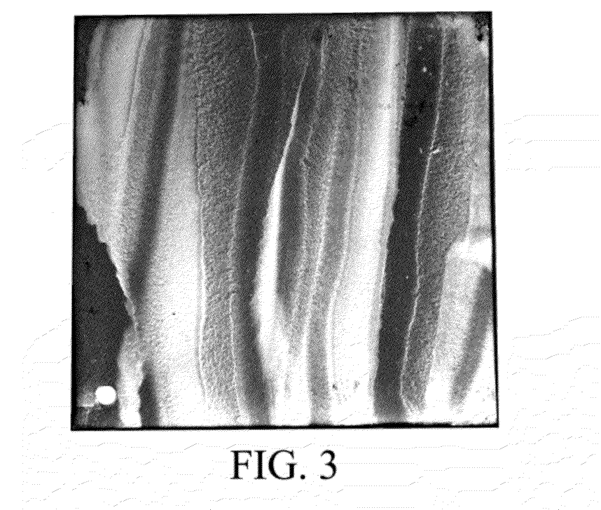

### DETAILED DESCRIPTION

The paint finish comprises a coat of a base paint, a coat of a decorative paint, a coat of silver sands, a first coat of clear oil, coat of a transparent paint, and a second coat of clear oil.

Suitable base paints include, without limitation, acrylic paints, oil paints such as alkyd paints, polyurethane paints, and other paints known to those skilled in the art that can be applied to objects made of metal, metal alloys, carbon fiber materials, or plastic materials. Preferably, the base paint is selected from the group consisting of acrylic paints, oil paints, and polyurethane paints.

Suitable decorative paints include, without limitation, acrylic paints, oil paints such as alkyd paints, polyurethane paints, and other paints known to those skilled in the art that can be applied to objects made of metal, metal alloys, carbon fiber materials, or plastic materials. Preferably, the decorative paint is selected from the group consisting of acrylic paints, oil paints, and polyurethane paints.

The term silver sands refers to a type of paint that provides a glittery, metallic appearance to the paint finish. For example, silver sands paint may be made from acrylic or alkyd resins, melamine, and PET silver powder.

Suitable transparent paints include, without limitation, acrylic transparent paints, oil transparent paints such as transparent alkyd paints, and other transparent paints known to those skilled in the art that can be applied to objects made of metal, metal alloys, carbon fiber materials, or plastic materials. Preferably, the transparent paint is selected from the group consisting of acrylic transparent paints and oil transparent paints.

Suitable clear oils include, without limitation, acrylic clear oil, alkyd clear oil, polyurethane clear oil, and other clear oils known to those skilled in the art that can be applied to objects made of metal, metal alloys, carbon fiber materials, or plastic materials. Preferably, the clear oil is selected from the group consisting of acrylic clear oil, alkyd clear oil, and polyurethane clear oil.

In addition, the coat of decorative paint incorporates a decorative effect. Examples of decorative effects include, without limitation, a laser effect, a splash effect, a cloud effect, or combinations thereof.

A laser effect is a decorative effect that resembles a laser beam. The laser effect can include a single laser beam or a plurality of laser beams. Each laser beam can be thin or wide and can have a uniform or variable width along the length of the laser beam. The length of a laser beam can extend the entire length or a fraction of the length of the underlying object. If the laser effect comprises a plurality of laser beams, the laser beams can be of the same color or can be of different colors.

The process for creating the laser effect comprises spraying droplets of the decorative paint so that the paint drips slowly over the coat of base paint. Typically, the droplet size is between about 1 mm and about 10 mm. Next, the droplets are spread to form a laser beam as described above. A blower or an empty spray gun can be used to spread the droplets and form the laser beams. The pressure of the blower or spray gun is approximately less than 4 kg/m², preferably between about 1 kg/m² and about 3 kg/m².

A splash effect is a decorative effect that resembles a spattered liquid. The process for creating the splash effect comprises spraying droplets of the decorative paint so that the paint drips slowly over the coat of base paint. Typically, the droplet size is between about 1 mm and about 10 mm. The droplets are spread in multiple directions by a blower or an empty spray gun, again resulting in a shape that resembles a spattered liquid. The pressure of the blower or spray gun is approximately less than 4 kg/m², preferably between about 1 kg/m² and about 3 kg/m².

Those skilled in the art will appreciate that the spray gun will need to be adjusted by reducing the flow rate, adjusting the nozzle, or both to achieve the desired droplet size. In addition, those skilled in the art will appreciate that other techniques known in the art can be used to spread the droplets of the decorative paint to obtain any of the decorative effects described above.

A cloud effect is a decorative effect that resembles a cloudy sky. The process for creating the splash effect comprises applying a coat of the decorative paint over the coat of base paint. The process further comprises spreading the previously applied decorative paint in a horizontal direction, a vertical direction, or in both directions relative to the orientation of the underlying object using an empty spray gun or a blower to form designs that resemble clouds. The pressure of the blower or spray gun is approximately less than 7 kg/m², preferably between about 2 kg/m² and about 6 kg/m².

The paint process to create a paint finish that incorporates a decorative effect comprises applying a coat of base paint to an object. Examples of suitable objects include, without limitation, objects made of metal or metal alloys, composite materials, plastic materials, and combinations thereof. More specific examples of suitable objects include, without limitation, scooter frames, bicycle frames, and tricycle frames. Examples of suitable metals or metal alloys include, without limitation, aluminum, steel, titanium, and other metals or metal alloys known to those skilled in the art. Examples of composite materials include, without limitation, carbon fiber and other composite materials known those skilled in the art. After the coat of base paint is applied to the object, the coat of base paint is partially cured until it is half dry.

The term “partially cured” and derivatives thereof means drying the coat of paint or oil at an elevated temperature above room temperature for a specified period of time without completely drying the coat of paint. The time and temperature will depend on the type of paint used and they are usually specified by the paint supplier. Typically a partially cured coat of paint is obtained by baking it in an oven at a temperature between about 100° C. and about 180° C., preferably between about 120° C. and about 170° C., for a period of time between about 5 minutes and 30 minutes, preferably between 8 minutes and 20 minutes. Those skilled in the art will appreciate that the temperature range and the time range to partially cure the coat of paint will vary depending on the paint used.

The term “half dry” and derivatives thereof refers to a coat of paint that has been partially cured. A common way to determine if the paint is half dry is by lightly pressing a finger on the painted surface after the paint has been baked and allowed to cool. If finger marks are visible on the painted surface, then the paint is considered to be half dry. Those skilled in the art will appreciate that this is not an exclusive method to determine if the paint is half dry and other methods known to those skilled in the art can be used.

Next, a decorative paint is applied over the coat of base paint to form a coat of a decorative paint. The manner of applying the decorative paint will vary depending on the decorative effect that will be incorporated into the paint finish.

For example, to obtain a laser effect, the decorative paint is applied by adjusting the flow rate of a spray gun so that droplets of the decorative paint drip slowly over the coat of base paint. The droplets are spread to form laser beams as described above.

To obtain a splash effect, the decorative paint is applied by adjusting the flow rate of a spray gun so that droplets of the decorative paint drip slowly over the coat of base paint. The droplets are spread to form spattered liquid designs as described above.

To obtain a cloud effect, the coat of decorative paint is applied over the coat of base paint. Then, the decorative paint is spread in a horizontal direction, a vertical direction, or both relative to the underlying object as described above.

After the decorative effect is created, the coat of decorative paint is partially cured until it is half dry. Those skilled in the art will appreciate that the coat of decorative paint may not cover the entire coat of base paint because some of the decorative effects, such as the laser effect, are not meant to cover the entire coat of base paint. Each coat of the paint finish may cover the entire area or less than the entire are of the underlying object and each coat may cover the same or a different area relative to each coat in the paint finish.

Those skilled in the art will appreciate that the coat of decorative paint may incorporate a single or a plurality of decorative effects. In the case of a plurality of decorative effects, this step of the process may have to be repeated for each decorative effect to be incorporated.

Next, a coat of silver sands is applied over the coat of a decorative paint. After the coat of silver sands is applied, the coat is partially cured until it is half dry.

Next, a first coat of clear oil is applied over the coat of silver sands. After the first coat of clear oil is applied, the coat is partially cured until it is half dry.

Next, a coat of transparent paint is applied over the coat of clear oil. After the coat of transparent paint is applied, the coat is partially cured until it is half dry.

Next, a second coat of clear oil is applied over the coat of transparent paint. After the second coat of clear oil is applied, the coat is completely cured until it is completely dry.

The term “completely cured” and derivatives thereof means drying the coat of paint or oil at an elevated temperature above room temperature for a specified period of time until the coat of paint is completely dry. The time and temperature will depend on the type of paint used and they are usually specified by the paint supplier. Typically a completely cured coat of paint is obtained by baking it in an oven at a temperature between about 110° C. and about 220° C., preferably between about 130° C. and about 200° C., for a period of time between about 5 minutes and 60 minutes, preferably between 15 minutes and 40 minutes. Those skilled in the art will appreciate that the temperature range and the time range to completely cure the coat of paint will vary depending on the paint used.

### Example 1

### Laser Effect

A metal tube was spray painted with a coat of a white base paint. The coat of white base paint was cured in an oven at about 130° C. until it was half dry—approximately 15 minutes. Using a spray gun having a reduced air flow, droplets of silver colored decorative paint were applied to the coat of base paint. Using a blower (or an air gun), a coat of decorative paint was formed by spreading the droplets of the silver colored decorative paint into relatively straight lines that resemble a laser beam creating a laser effect. The coat of decorative paint was cured in an oven at about 130° C. until it was half dry—approximately 15 minutes. A coat of silver sands was applied over the coat of decorative paint and it was cured in an oven at about 130° C. until it was half dry—approximately 15 minutes. A coat of clear oil was applied over the coat of silver sands and it was cured in an oven at about 130° C. until it was half dry approximately 15 minutes. A coat of transparent orange paint was applied over the coat of clear oil and it was cured in an oven at about 130° C. until it was half dry—approximately 15 minutes. A coat of clear oil was applied over the coat of transparent yellow paint and it was cured in an oven at about 160° C. until it was completely dry—approximately 25 minutes.

### Example 2

### Splash Effect

A metal tube was spray painted with a coat of a white base paint. The coat of white base paint was cured in an oven at about 130° C. until it was half dry—approximately 15 minutes. Using a spray gun having a reduced air flow, droplets of metallic silver colored decorative paint were applied to the coat of base paint. Using a blower (or an air gun), a coat of decorative paint was formed by spreading the droplets of metallic silver colored decorative paint to simulate spattering the droplets to create a splash effect. The coat of decorative paint was cured in an oven at about 130° C. until it was half dry—approximately 15 minutes. A coat of silver sands was applied over the coat of decorative paint and it was cured in an oven at about 130° C. until it was half dry—approximately 15 minutes. A coat of clear oil was applied over the coat of silver sands and it was cured in an oven at about 130° C. until it was half dry approximately 15 minutes. A coat of transparent yellow paint was applied over the coat of clear oil and it was cured in an oven at about 130° C. until it was half dry—approximately 15 minutes. A coat of clear oil was applied over the coat of transparent yellow paint and it was cured in an oven at about 160° C. until it was completely dry—approximately 25 minutes.

### Example 3

### Cloud Effect

A metal tube was spray painted with a coat of a white base paint. The coat of white base paint was cured in an oven at about 130° C. until it was half dry—approximately 15 minutes. A coat of transparent red decorative paint was spray painted over the coat of base paint. Using a blower (or an air gun), the decorative paint was blown along the length of the metal tube to create the cloud effect. The coat of decorative paint was cured in an oven at about 130° C. until it was half dry—approximately 15 minutes. A coat of silver sands was applied over the coat of decorative paint and it was cured in an oven at about 130° C. until it was half dry approximately 15 minutes. A coat of clear oil was applied over the coat of silver sands and it was cured in an oven at about 130° C. until it was half dry—approximately 15 minutes. A coat of transparent yellow paint was applied over the coat of clear oil and it was cured in an oven at about 130° C. until it was half dry—approximately 15 minutes. A coat of clear oil was applied over the coat of transparent yellow paint and it was cured in an oven at about 160° C. until it was completely dry—approximately 25 minutes.

All the paints and oils used in the foregoing examples were supplied by Yung Shyang Chemical Industrial Co., Ltd. and Donbon Paints Industrial Co., Ltd., both of Taiwan. The table below identifies some of the materials used in the examples.

| | Color Part Number |
|---|---|
| Paint/Oil | or Specification |
| White base paint | DC-025 |
| Silver decorative paint | DB-6311 |
| Silver Sands | CH-907 |
| Transparent orange paint | P.021c |
| Metallic silver decorative paint | YS-754 |
| Transparent yellow paint | P.012C |
| Transparent light yellow paint | P.100C |
| Transparent red paint | P.032C |

It will be apparent to those skilled in the art that changes and modifications may be made in the embodiments illustrated herein, without departing from the spirit and the scope of the invention. Thus, the invention is not to be limited to the particular forms herein shown and described except insofar as indicated by the scope of the following claims.

1. A paint finish comprising:
a coat of a base paint;
a coat of a decorative paint;
a coat of silver sands;
a coat of a first clear oil;
a coat of a transparent paint; and
a coat of a second clear oil.

2. The paint finish of claim 1 wherein the coat of a decorative paint comprises a decorative effect selected from the group consisting of a laser effect, a splash effect, a cloud effect, and a combination thereof.

3. A paint process comprising:
applying a coat of base paint to a substrate;
partially curing the coat of base paint;
applying a decorative paint over the coat of base paint to form a coat of decorative paint having a decorative effect;
partially curing the coat of decorative paint;
applying a coat of silver sands over the coat of decorative paint;
partially curing the coat of silver sands;
applying a first coat of clear oil over the coat of silver sands;
partially curing the first coat of clear oil;
applying a coat of transparent paint over the first coat of clear oil;
partially curing the coat of transparent paint;
applying a second coat of clear oil over the coat of transparent paint; and
completely curing the second coat of clear oil.

4. The paint process of claim 3 wherein the decorative effect is made by a process comprising spraying droplets of the decorative paint over the base paint and spreading the droplets of decorative paint to create a design that resembles a laser beam.

5. The paint process of claim 3 wherein the decorative effect is made by a process comprising spraying droplets of the decorative paint over the base paint and spreading the droplets of decorative paint to create a design that resembles a spattered liquid.

6. The paint process of claim 3 wherein the decorative effect is made by a process comprising spraying the decorative paint over the base paint and blowing the decorative paint to create a design that resembles clouds.

7. The paint process of claim 3 wherein the surface is at least a portion of a frame selected from the group consisting of a scooter frame, a bicycle frame, and a tricycle frame.

8. The paint process of claim 3 wherein each of the partially curing steps comprises drying the coat between about 100° C. and 180° C. until the coat is half dry.

9. The paint process of claim 8 wherein each of the partially curing steps comprises drying the coat at about 130° C. until the coat is half dry.
